(19) United States
(12) Patent Application Publication
(10) Pub. No.: US 2005/0161064 A1
(43) Pub. Date: Jul. 28, 2005

(54) Method and apparatus for controlling the water temperature in a dishwasher

(76) Inventor: Michael T. Clouser, Brownsburg, IN (US)

Correspondence Address: HARNESS, DICKEY & PIERCE, P.L.C., P.O. BOX 828, BLOOMFIELD HILLS, MI, 48303, US

(21) Appl. No.: 10/767,968

(22) Filed: Jan. 28, 2004

(51) Int. Cl. B08B 3/10

(52) U.S. Cl. 134/57 D; 134/56 R; 134/57 R; 134/58 D; 134/105; 134/108; 134/113

(57) ABSTRACT

A dishwasher comprising a heating element having a resistance adapted to change in response to the water temperature in the dishwasher, and a data processing unit coupled to the heating element for measuring the resistance of the heating element and determining the water temperature in the dishwasher using the resistance measurement.

### FIELD OF THE INVENTION

The present invention generally relates to a method for controlling the water temperature in a dishwasher.

### BACKGROUND OF THE INVENTION

Maintaining a specific water temperature in a dishwasher is important for many reasons, including for example, aiding in the removal of dried food from dishes, and in the sanitizing of the dishes.

Typically, most modern dishwashers employ a thermistor in connection with a microprocessor and a timer for controlling the water temperature in the dishwasher. In this configuration, once a user selects a desired cycle, a pre-set temperature is determined. As such, the water temperature in the dishwasher is controlled around the pre-set temperature by continuously measuring the current water temperature using the thermistor. The timer typically runs the dishwasher in a pre-determined pattern based on the cycle selected. The timer helps provide power to all of the dishwasher components at a certain time, for a certain period of time. In this case, the timer with the direction from the microprocessor, performs the function of enabling the heating element to turn on and off in response to the water temperature at certain times during the cycle. For example, if the measured water temperature is below the pre-set temperature, the timer turns the heating element on for a certain period of time in order to reach the pre-set temperature and turns the heating element off when the time has elapsed. The thermistor, in connection with the microprocessor, is used to measure the water temperature in the dishwasher at any given time. The microprocessor determines whether the water temperature has reached the pre-set temperature.

While current dishwashing systems perform adequately for their intended uses, they are subject to improvement. Specifically, the thermistors can be a source of water leaks as they must be in contact with the water supply to be useful. Positioning a thermistor so that its reading reflects the actual temperature of the entire charge of water can be problematic. Often thermistors are placed in a sump cavity and must depend on the water being pumped past them for their water temperature information.

Therefore, there is a need for a better method of controlling the water temperature and accurately measuring the water temperature in the dishwasher.

### SUMMARY OF THE INVENTION

The invention provides a dishwasher comprising a heating element having a resistance adapted to change in response to the water temperature in the dishwasher and a data processing unit coupled to the heating element for measuring the resistance of the heating element and determining the water temperature in the dishwasher.

The invention also provides a method for controlling the water temperature in a dishwasher comprising providing a heating element having a resistance adapted to change in response to the water temperature in the dishwasher, filling the dishwasher to a desired water level, measuring the resistance of the heating element, and determining the water temperature in the dishwasher according to the resistance of the heating element.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a simplified schematic representation of a dishwasher according to the invention; and

FIG. 2 is a flowchart illustrating the operational steps of the dishwasher according to the invention.

### DETAILED DESCRIPTION OF THE PREFERRED EMBODIMENTS

The following description of the preferred embodiments is merely exemplary in nature and is in no way intended to limit the invention, its application, or uses.

The present invention provides a dishwasher that employs a method for controlling and accurately measuring the water temperature in a dishwashing chamber of the dishwasher. The method includes using the heating element provided in the dishwasher for heating the water and directly measuring the resistance of the heating element before and after the dishwashing chamber of the dishwasher is filled with water. The resistance of the heating element, when it is unenergized, is used to determine the temperature of the water in the dishwasher. This resistance information is used to compute how long the heating element is energized to a reach a target water temperature for the pre-selected washing cycle.

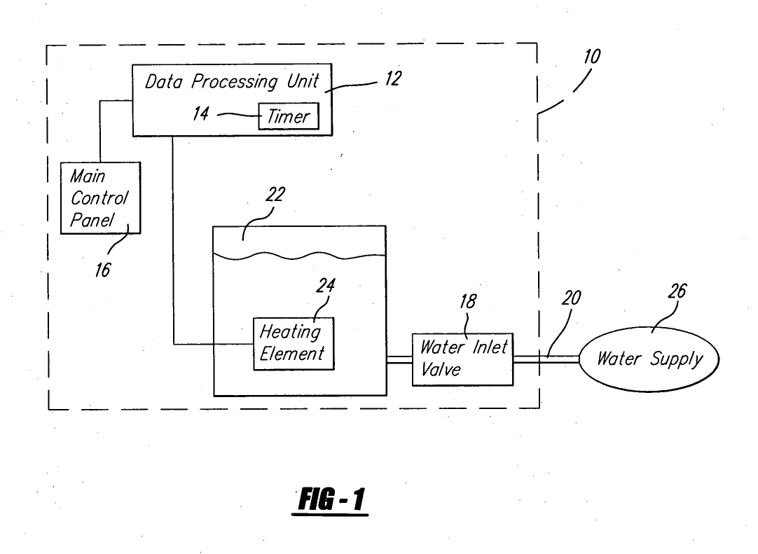

FIG. 1 is a schematic representation of a dishwasher 10 according to the present invention. At the outset, the schematic depicts the major components of the dishwasher 10. Other known components that serve to complete the dishwasher, however, are not shown, such as, for example, a motor and pump assembly for re-circulating the water for washing or rinsing, and draining the dishwasher.

It should be readily understood that the dishwasher 10 according to the present invention does not include a thermistor that is typically employed for measuring the water temperature of the dishwasher. Rather, the water temperature is computed by using the measured resistance of the heating element itself.

The dishwasher 10 generally comprises a data processing unit 12 with a timer 14, a main control panel 16, a water-inlet valve 18, a conduit 20, a dishwashing chamber 22, and a heating element 24. The data processing unit 12 is in communication with the main control panel 16, the water-inlet valve 18, and the heating element 24. Specifically, the data processing unit 12 performs the functions of receiving an input and sending an output to either one of the components. It should be understood that the data processing unit 12 can be any type of commercially available processor for executing instructions and processing data.

The timer 14 is generally located behind the main control panel 16 and is connected with the data processing unit 12. The timer 14 can be either a mechanical device, such as, for example, a simple clock, or an electronic device capable of providing a digital signal to the data processing unit 12. The timer 14 is used as a standard counting device. The timer 14 helps provide power to all of the dishwasher components at a pre-set time and for a pre-set period of time as computed by the data processing unit 12.

The user operated main control panel 16 is generally located at the front top of the dishwasher. The main control panel 16 includes one or more selector switches. The switches provide options among wash cycles, drying cycles (heat or no heat), temperatures for the wash or rinse, and so on. The wash cycle selected from the switches of the panel 16 is used to calculate the pre-set time for the timer 14. These switches may include, for example, an option for a heavy, medium, and a light cycle. For instance, when the user selects the heavy cycle, the target resistance and the desired water temperature are determined automatically by the data processing unit 12. The desired water temperature varies according to the selected wash cycle. Each cycle can have a different pre-set water temperature. It should be understood that the main control panel 16 may include a number of options that can be considered as a factor in determining the desired water temperature.

The water-inlet valve 18 is generally located at the bottom left or right of the dishwasher and in communication with the data processing unit 12. The water-inlet valve 18 is connected to a water supply 26 by conduit 20 to allow water to flow into the dishwashing chamber 22 for the selected wash cycle. The water-inlet valve 18 is typically attached to a hot-water supply line of the water supply 26. The water-inlet valve 18 is controlled by the timer 14 and the data processing unit 12. The timer 14 turns the water-inlet valve 18 on and off for a length of time calculated by the data processing unit 12. Specifically, the timer 14 opens and closes the water-inlet valve 18 for the calculated length of time to allow water into the dishwashing chamber 22. The water-inlet valve 18 closes when the timer 14 cuts off the flow of power to the water-inlet valve 18. The timer 14 keeps the water-inlet valve 18 open for the length of time until the dishwashing chamber 22 has filled to the desired level.

The dishwashing chamber 22 is located within the body of the dishwasher 10. The dishwashing chamber 22 is the region where the washing and rinsing takes place. The dishwashing chamber 22 includes a number of components that are not shown, such as supporting racks for loading the dishes, a pump assembly and spray arms for spraying water onto the dishes, a soap dispenser for providing soap, a drain and a solenoid drain valve for draining the wash water through a hose and out to a plumbing waste system. It should be understood that the dishwashing chamber 22 can be any size and shape suitable for the various washing cycles.

The heating element 24 is located within the body of the dishwashing chamber 22 and is adapted to be submerged in water. The heating element is generally located in the sump area of the dishwashing chamber 22. The heating element 24 is typically made of wire wrapped around a core and is nearly entirely resistive. As such, when the temperature of the water changes, the resistance of the heating element 24 changes accordingly. In doing so, the water temperature can be inferred by the resistance of the heating element 24. The heating element 24, when not energized, essentially acts as a resistor with positive temperature coefficient (PTC) characteristics and may, therefore, be used as a sensor. The data processing unit 12 enables the heating element 24 to turn on and off for a predetermined length of time in order for the pre-set temperature to be reached.

In a preferred aspect of the invention, the resistance of the heating element 24 is measured after the heating element 24 has been submerged in water. In this case, if the target resistance has not been reached, the heating element 24 is energized by the timer 14 for a predetermined period of time that is calculated by the data processing unit 12. The heating element is then de-energized and allowed to stabilize. Once stabilized, another resistance measurement is then taken to determine whether the target resistance has been reached based on the actual resistance of the heating element 24. If the target resistance has been reached, then the washing cycle is continued. If the target resistance has not been reached, then the heating element 24 is re-energized and measured again after another predetermined period of time.

In another preferred aspect of the invention, the resistance of the heating element 24 is measured before and after being submerged in water. In doing so, the resistance of the heating element 24 is determined so that the timer 14 along with the data processing unit 12 can determine a period of time to operate the heating element 24 to reach the target resistance. In this case, if the target resistance has not been reached, the heating element 24 is re-energized by the timer 14 during another predetermined period of time. Another resistance measurement is then taken to determine whether the target resistance has been reached based on the actual resistance of the heating element 24. If the target resistance has been reached, then the washing cycle is continued. If the target resistance has not been reached, then the heating element 24 is re-energized and measured again during another predetermined period of time.

The data processing unit 12 is used to measure the resistance of the heating element 24 and determine whether or not the target resistance has been reached based on the actual resistance. The data processing unit 12 controls the timer 14 along with the heating element 24 to bring the water to the pre-set temperature by bringing the heating element 24 to the target resistance. This is accomplished by using pre-stored data in the data processing unit 12 that includes a number of target resistances that correspond to a number of water temperatures. As such, when a washing cycle is selected, a target resistance and a corresponding water temperature is retrieved from the data.

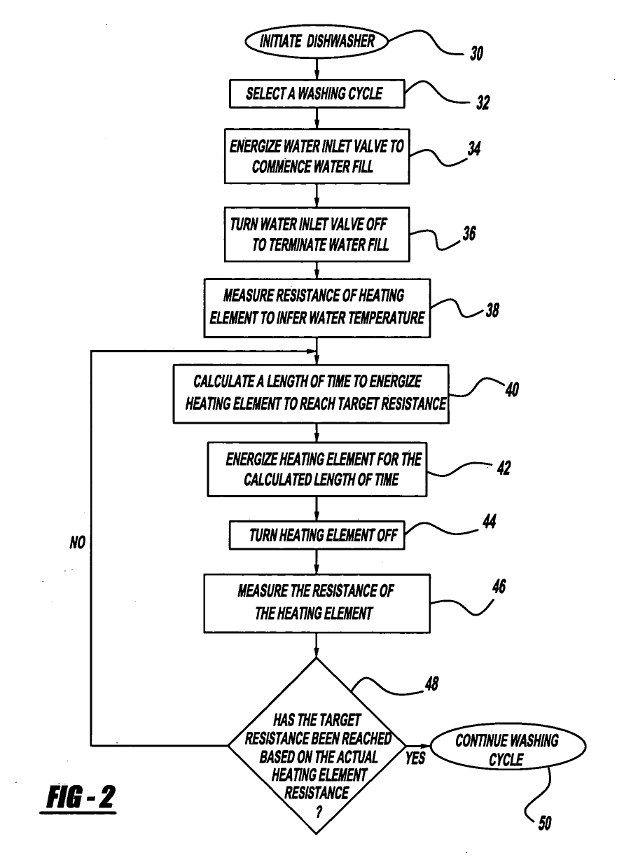

FIG. 2 is a flowchart illustrating the operational steps of the dishwasher 10. Dishwasher 10 is initiated at 30. At 32, a washing cycle is selected. As such, a target resistance is determined by the data processing unit 12. At 34, the water-inlet valve 18 is energized to commence water fill, thus filling the dishwashing chamber 22 to the desired water level. Next, at 36, the water-inlet valve 18 is turned off to terminate the water fill. At 38, the resistance of the heating element 24 is measured, which corresponds to the water temperature. Then, the period of time to energize the heating element 24 to reach the target resistance is calculated at 40. At 42, the heating element 24 is energized for the calculated period of time. At 44, the heating element 24 is turned off. Next, the resistance of the heating element 24 is measured at 46. At 48, the data processing unit 12 determines whether the target resistance has been reached based on the actual resistance of the heating element 24. If the answer is yes, then continue washing cycle at 50. If the answer is no, 40-48 are repeated. This process continues until the target resistance has been reached. However, it should be understood that the target resistance will most likely be reached by the second determination of a period of time.

It should be understood that the method of measuring a heating element to infer water temperature can be extendable to other systems, such as, for example, a washing machine. The present invention provides for a more accurate method of measuring the water temperature in a dishwasher, while eliminating a current existing component.

The description of the invention is merely exemplary in nature and, thus, variations that do not depart from the gist of the invention are intended to be within the scope of the invention. Such variations are not to be regarded as a departure from the spirit and scope of the invention.

1. A dishwasher comprising:
a heating element having a resistance adapted to change in response to the water temperature in the dishwasher; and
a data processing unit coupled to the heating element operative to measure the resistance of the heating element and determine the water temperature in the dishwasher using the resistance measurement.

2. The dishwasher of claim 1, further comprising a control panel for providing a plurality of wash cycles.

3. The dishwasher of claim 2, wherein the selection of at least one of the pluarlity of wash cycles sets a target resistance for the heating element and a desired water temperature for the dishwasher.

4. The dishwasher of claim 3, wherein the target resistance corresponds to the desired water temperature for the selected wash cycle and is selected from a plurality of pre-stored data including a plurality of target resistances that correspond to a plurality of water temperatures.

5. The dishwasher of claim 3, wherein the data processing unit is operative to control the heating element to reach the target resistance.

6. The dishwasher of claim 3, wherein the data processing unit is operative to calculate a period of time for energizing the heating element to reach the target resistance.

7. The dishwasher of claim 6, further comprising a timer in connection with the data processing unit for energizing the heating element for the calculated period of time.

8. The dishwasher of claim 1, further comprising a water valve coupled to a water supply for providing water to the dishwasher.

9. The dishwasher of claim 8, wherein the data processing unit is operative to control the water valve to open and close.

10. The dishwasher of claim 1, wherein the heating element has a positive temperature coefficient characteristic.

11. A dishwasher comprising:
a heating element operative to change in resistance in response to the water temperature in the dishwasher;
a processing system coupled to the heating element, the system is operative to measure the resistance of the heating element and determine the water temperature in the dishwasher using the resistance measurement;
a control panel coupled to the processing system, the control panel is operative to set a target resistance and a desire water temperature;
a water supply operative to provide water to the dishwasher;
a valve device coupled to the water supply, the valve device is operative to open and close the supply of water flowing in the dishwasher from the water supply; and
a timer coupled to the processing system, the timer is operative to control the function of the heating element.

12. The dishwasher of claim 11, wherein the control panel includes a plurality of wash cycles where the selection of at least one of the plurality of wash cycles sets the target resistance and the desired water temperature.

13. The dishwasher of claim 11, wherein the processing system along with the timer is operative to calculate a length of time for energizing the heating element to reach the target resistance and the desired water temperature.

14. The dishwasher of claim 11, wherein the target resistance corresponds to the desired water temperature.

15. The dishwasher of claim 11, wherein the resistance of the heating element corresponds to the water temperature in the dishwasher.

16. The dishwasher of claim 11, wherein the heating element has a positive temperature coefficient characteristic.

17. A method for controlling the water temperature in a dishwasher comprising:
providing a heating element having a resistance adapted to change in response to the water temperature in the dishwasher;
filling the dishwasher to a desired water level;
measuring the resistance of the heating element; and
determining the water temperature in the dishwasher based on the resistance of the heating element, wherein the resistance of the heating element corresponds to the water temperature.

18. The method of claim 17, further comprising:
setting a target resistance that corresponds to the desired water temperature from a plurality of pre-stored data that includes a plurality of target resistances that correspond to a plurality of water temperatures;
calculating a period of time for energizing the heating element to the target resistance; and
energizing the heating element to reach the target resistance.

19. The method of claim 18, further comprising:
comparing the resistance of the heating element to the target resistance; and
determining if the resistance of the heating element has reached the target resistance.

20. The method of claim 18, further comprising selecting at least one of a plurality of washing cycles, wherein selecting the at least one of the plurality of washing cycles sets the target resistance and the desired water temperature.

21. The method of claim 17, further comprising providing the heating element with a positive temperature coefficient characteristic.

22. A method for controlling the water temperature in a dishwasher comprising:
providing a heating element having a resistance adapted to change in response to the water temperature in the dishwasher;
selecting a target resistance from a plurality of pre-stored data;
filling the dishwasher to a desired water level;
measuring the resistance of the heating element in the dishwasher; and
energizing the heating element to reach the target resistance, wherein the resistance of the heating element corresponds to the water temperature in the dishwasher.

23. The method of claim 22, further comprising selecting at least one of a plurality of wash cycles that sets the target resistance.

24. The method of claim 23, further comprising having the target resistance correspond to the desired water temperature for the selected wash cycle.

25. The method of claim 22, further comprising:
computing a length of time for energizing the heating element to reach the target resistance;
energizing the heating element for the period of time to reach the target resistance;
comparing the resistance of the heating element to the target resistance; and
determining if the resistance of the heating element has reached the target resistance.

26. The method of claim 22, further comprising providing the heating element with a positive temperature coefficient characteristic.

27. A method for controlling the water temperature of a dishwasher comprising:
providing a heating element having a resistance adapted to change in response to the water temperature in the dishwasher;
selecting at least one of a pluarlity of washing cycles;
setting a target resistance for the heating element;
calculating a length of time for energizing the heating element to reach the target resistance; and
energizing the heating element for the calculated length of time to reach the target resistance, wherein the target resistance corresponds to a desired water temperature for the selected washing cycle.

28. The method of claim 27, further comprising:
comparing the resistance of the heating element to the target resistance; and
determining if the resistance of the heating element has reached the target resistance.

29. The method of claim 27, further comprising providing the heating element with a positive temperature coefficient characteristic.
